(19) United States
(12) Patent Application Publication
(10) Pub. No.: US 2003/0182867 A1
(43) Pub. Date: Oct. 2, 2003

(54) Stone polishing pad containing cork powder and method for manufacturing the same

(76) Inventor: Shuk-dae Son, Gyunggi-do (KR)

Correspondence Address: LADAS & PARRY, 224 SOUTH MICHIGAN AVENUE, SUITE 1200, CHICAGO, IL, 60604, US

(21) Appl. No.: 10/238,316

(22) Filed: Sep. 10, 2002

(30) Foreign Application Priority Data
Apr. 2, 2002 (KR) 2002-18046

(51) Int. Cl. C09K 3/14; B24D 3/00

(52) U.S. Cl. 51/293; 51/298; 51/307

(57) ABSTRACT

Disclosed are a mixture of a stone polishing pad, a stone polishing pad made of the mixture and a method for manufacturing the stone polishing pad. Instead of planar structure, the stone polishing pad has polishing protrusions and an uneven surface formed on the surface of the polishing protrusions that contacts with the polished object. The stone polishing pad is formed by charging a mould with the mixture of the stone polishing pad that includes cork powder, and forming the same under high temperature and high pressure.

### BACKGROUND OF THE INVENTION

1. Field of the Invention

The present invention generally relates to a stone polishing pad, and more particularly, it relates to a mixture of raw materials of a stone polishing pad and a cork powder, a stone polishing pad made of such mixture, and a method for manufacturing the stone polishing pad.

2. Description of the Prior Art

Generally, a stone polishing pad refines the surfaces of marbles or granites (hereinafter called a ‘polished object’), thereby giving a glossiness on the surface of the polished object. As for the raw materials of such stone polishing pad, there are mainly diamond powder and phenolic resin binder, with the addition of fillers such as calcium carbonate or talc.

When the polished object is polished by the conventional stone polishing pad made of the above-described raw materials, the rigidity of the stone polishing pad usually causes an overheat between the stone polishing pad and the polished object. The overheat causes damages to the surface of the polished object such as a discoloration. In addition, as the minute segments are scratched out from the polished object and the stone polishing pad during the abrasion, there is a problem that the minute segments stick to the surface of the polished object due to the overheat. Accordingly, it is inconvenient for a user because he/she has to remove the minute segments from the polished object after the polishing process.

As shown in FIGS. 1A and 1B, the conventional stone polishing pad 1 made of the raw materials as described above has a hub 2. The surface of the stone polishing pad 1 contacting with the polished object 3 is plane. As the contacting surface of the stone polishing pad 1 is plane, frictional force generated between the polished object 3 and the stone polishing pad 1 during abrasion is not enough to scratch out the diamond powder sufficiently. As the diamond powder, which contributes to obtaining the stone polishing effect, is scratched out in insufficient amount, satisfactory glossiness is not expected especially in the beginning of the polishing process.

### SUMMARY OF THE INVENTION

Accordingly, it is an object of the present invention to provide a mixture of a stone polishing pad capable of controlling an overheat from generating between a polished object and a stone polishing pad during an abrasion, thus preventing damage to a surface of the polished object, and a stone polishing pad made of the mixture of the store polishing pad, and a method for manufacturing the stone polishing pad.

It is another object of the present invention to provide a mixture of a stone polishing pad capable of preventing minute segments, which are scratched out from the polished object and stone polishing pad during abrasion, from sticking to the surface of the polished object, thus keeping the surface of the polished object clean, and a stone polishing pad made of the mixture of the stone polishing pad, and a method for manufacturing the stone polishing pad.

It is yet another object of the present invention to provide a stone polishing pad capable of causing a strong frictional force to be produced between the polished object and the stone polishing pad during abrasion, so that diamond powder, which contributes to obtaining the stone polishing effect, can be scratched out from the stone polishing pad easily to refine the surface of the polished object even in the beginning of the polishing process.

The above object is accomplished by a mixture of a stone polishing pad according to the present invention, including raw materials of the stone polishing pad and a cork powder. The cork powder is present in the mixture in amount ranging from about 5 to about 15 weight percent of the weight of the mixture. The raw materials of the stone polishing pad include diamond powder and phenolic resin binder. A filler of a calcium carbonate or a talc can be added as a replacement for the phenolic resin binder in the amount equal to the amount of the phenolic resin binder.

Another object is accomplished by a method for manufacturing a stone polishing pad according to the present invention, including the steps of forming a mixture of raw materials of the stone polishing pad and a cork powder; charging a mould with the mixture; and putting the mould in a high-temperature and high-pressure press for forming.

The cork powder is added in the mixture in the mixture forming step in amount ranging from about 5 to about 15 weight percent of the weight of the mixture.

According to the present invention, the stone polishing pad is formed in the shape of a plate, and has a hub to be connected with a stone polisher for a rotation. The stone polishing pad also has polishing protrusions, and the surface of the polishing protrusions that contacts with the polished object is uneven.

### BRIEF DESCRIPTION OF THE DRAWINGS

The above-mentioned object and the feature of the present invention will be more apparent by describing the preferred embodiment of the present invention by referring to the appended drawing, in which:

FIG. 1A is a perspective view of a conventional stone polishing pad;

FIG. 1B is a perspective view showing the conventional stone polishing pad being connected with a stone polisher;

FIG. 2 is a view showing the process of manufacturing a stone polishing pad according to the present invention;

FIG. 3 is a perspective view of a stone polishing pad according to the present invention;

FIG. 4A is a perspective view of a polishing protrusion of the stone polishing pad according to the present invention;

FIG. 4B is a sectional view of the polishing protrusion of the stone polishing pad according to the present invention; and

FIG. 5 is a side view showing the stone polishing pad being connected with a stone polisher.

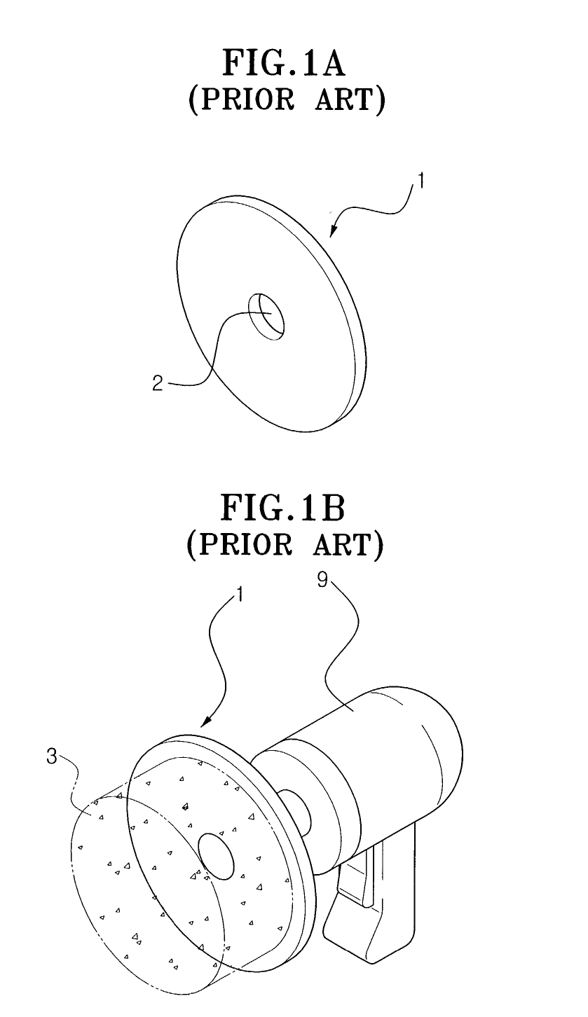

### DETAILED DESCRIPTION OF THE PREFERRED EMBODIMENT

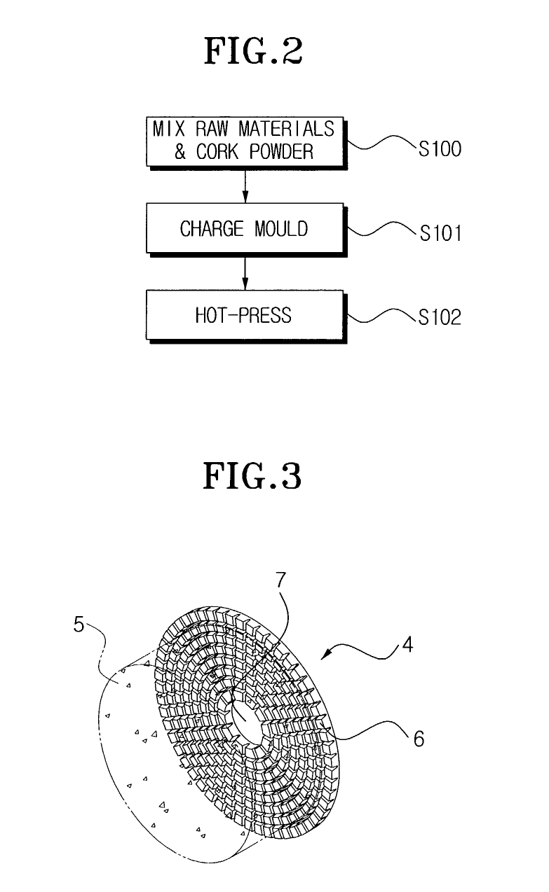

A method for manufacturing a stone polishing pad according to the present invention will be described below in greater detail with reference to FIG. 2.

First, as shown in FIG. 2, a cork powder is added in the raw materials of the stone polishing pad, thus, a mixture of the cork powder and raw materials is prepared (step S100). The mixture is charged in a mould (step S101). As the mold undergoes heating and compression under high temperature and high pressure in step S102, the stone polishing pad is completed. According to the preferred embodiment of the present invention, the temperature for molding process is preferably between 150° C.-170° C., and the pressure between 50 kg/cm² 150 kg/cm².

The stone polishing pad is formed in a plate shape, and has a hub to be connected with a stone polisher for a rotation, and also has polishing protrusions. The polishing protrusions have an uneven surface formed on the contacting surface contacting with the polished object.

The stone polishing pad according to the preferred embodiment of the present invention will be described below with reference to FIGS. 3 through 5.

Referring to FIG. 3, in order to increase the frictional force with the polished object5, the polishing protrusions 6 of equal size are arranged on the polishing pad 4 of circular-plate shape in a radial direction. The polishing protrusions 6 are arranged with respect to the hub 7 of the polishing pad 4.

More specifically, the polishing protrusions 6 have the shape of a sector, from which a smaller sector in the neighborhood of the hub 7 is cut off.

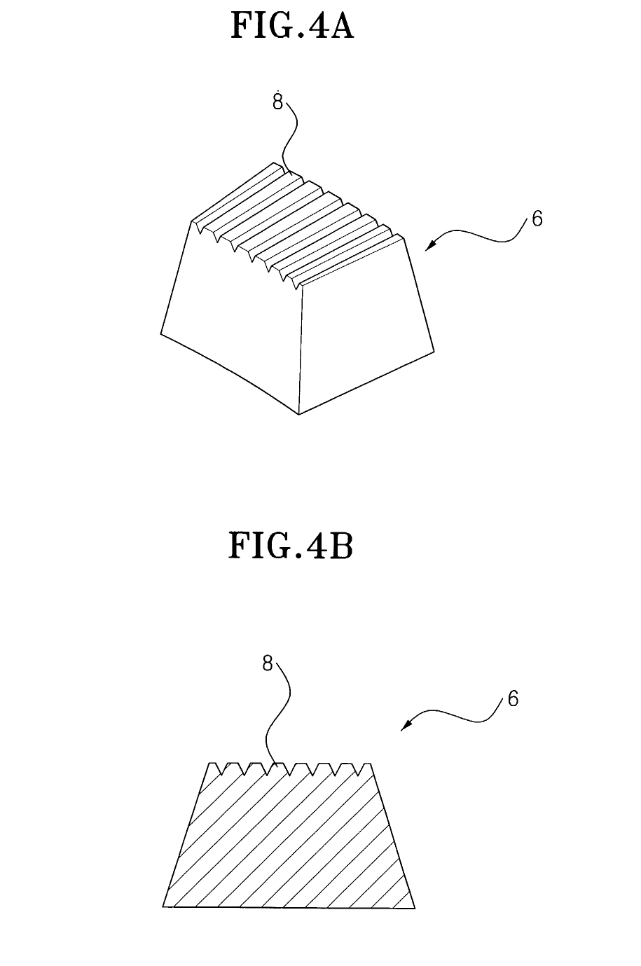

The surface of the polishing protrusions 6 contacting with the polished object 5 are uneven, and more specifically, such uneven surface 8 is formed in a linear pattern (see FIGS. 4A and 4B).

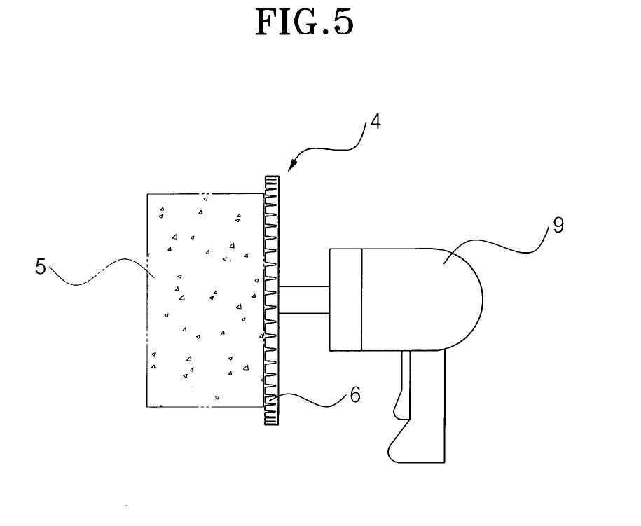

FIG. 5 shows the polishing pad 4 in contact with both a stone polisher 9 in rotational movement, and the polished object 5. As shown, due to the uneven surface of the polishing protrusions 6 of the polishing pad 4, a stronger frictional force is generated between the polished object 5 and the stone polishing pad 4 compared to the conventional case where the polishing pad 4 having a plane surface is used. As a result, diamond powder and cork powder, which contribute to obtaining the polishing effect of the polishing pad 4, are easily scratched out from the polishing pad 4.

The polishing pad 4 can have various shapes like a rectangular plate, a pentagonal plate, or a hexagonal plate. Also, the polishing protrusions 6 can be arranged on the polishing pad 4 in a radial direction with respect to the hub 7 in a gradually increasing size. Further, the uneven surface of the polishing protrusions 6 can be formed in various patterns such as a wavy pattern and a check pattern, or the uneven surface 8 can be formed with no specific pattern at all.

The mixture of the stone polishing pad is prepared by adding cork powder in the raw materials of the stone polishing pad. The raw materials comprise diamond powder and phenolic resin binder, with an addition of a filler such as a calcium carbonate or talc as a replacement to the phenolic resin binder. The cork powder is present in the mixture in amount ranging from about 5 to about 15 weight percent of the weight ofthe mixture.

Hereinbelow, the mixture of the stone polishing pad according to the preferred embodiment of the present invention will be described in greater detail.

Following are examples of the mixture of the stone polishing pad according to the present invention:

[Example 1]

The cork powder 2g is added in the diamond powder 2g and phenolic resin binder 16g.

[Example 2]

The cork powder 2g is added in the diamond powder 2g, phenolic resin binder 10g and calcium carbonate 6g.

[Example 3]

The cork powder 2g is added in the diamond powder 2g, phenolic resin binder 10g, calcium carbonate 2g and talc 4g.

According to the present invention, the cork powder is added in the raw materials of the stone polishing pad, to prevent overheat from generating in the polished object and the stone polishing pad during abrasion. As a result, damages to the surface of the polished object during the abrasion, such as discoloration, can be prevented.

Further, the cork has numerous cavities formed therein. Accordingly, as the minute segments are scratched out from the polished object and the stone polishing pad during abrasion, the minute segments are received in the cavities of the cork. As a result, the user no longer needs to remove the segments from the surface of the polished object after the polishing process because there are no segments sticking to the surface of the polished object.

Meanwhile, as described above, the stone polishing pad has the polishing protrusions having uneven surface to be contacted with the polished object. Due to the presence of protrusions and uneven surface, strong frictional force is produced between the polished object and the stone polishing pad during abrasion. Accordingly, the diamond powder and the cork powder are scratched out very easily, and the diamond powder causes the surface of the polished object to be polished and refined to have satisfactory glossiness from the beginning of the polishing process. As it can be seen, unlike in the conventional cases where the polishing process is carried out by eight steps, the polishing process can be achieved by five steps according to the present invention, which is advantageous in terms of saving time and money.

According to the present invention, the contacting surface of the stone polishing pad contacting with the polished object has plural polishing protrusions and uneven surface. Accordingly, the stronger frictional force is produced between the stone polishing pad and the polished object during abrasion, causing the diamond powder to be scratched out from the stone polishing pad very easily. As the diamond powder, which contributes to obtaining the polishing effect, is scratched out from the stone polishing pad very easily, satisfactory glossiness can be expected even in the beginning of the abrasion. Accordingly, as the polishing process is carried out in five steps, i.e. in reduced number of steps compared to the conventional cases, time and money can be saved.

Further, damage to the surface of the polished object is prevented because the overheating is prevented due to the presence of the cork powder added in the raw materials of the stone polishing pad. In addition, as the minute segments are scratched out from the polished object and the stone polishing pad, the minute segments are received in the cavities of the cork. As a result, damages to the surface of the polished object such as discoloration are prevented, and the user does not experience inconvenience of having to remove segments of the stone polishing pad and the polished object from the surface of the polished object. Finally, time and cost can also be saved.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A mixture of a stone polishing pad, comprising raw materials of the stone polishing pad, and a cork powder added in the raw materials.

2. The mixture of the stone polishing pad of claim 1, wherein the raw materials of the stone polishing pad comprise a diamond powder and a phenolic resin binder.

3. The mixture of the stone polishing pad of claim 1, wherein the cork powder is present in amount ranging from about 5 to about 15 weight percent of the weight of the mixture.

4. The mixture of the stone polishing pad of claim 1, further comprising at least one of a calcium carbonate and a talc.

5. A stone polishing pad made of a mixture that includes raw materials of the stone polishing pad and a cork powder.

6. The stone polishing pad of claim 5, being in the shape of a plate, and comprising a hub and polishing protrusions.

7. The stone polishing pad of claim 6, wherein a contacting surface of the polishing protrusions that contacts with a polished object is uneven.

8. The stone polishing pad of claim 7, wherein the uneven surface is formed in a linear pattern.

9. A method for manufacturing a stone polishing pad, comprising the steps of:
forming a mixture of raw materials of the stone polishing pad and a cork powder;
charging a mould with the mixture; and
putting the mould in a high-temperature and high-pressure press for forming.

10. The method for manufacturing the stone polishing pad of claim 9, wherein the cork powder is present in amount ranging from about 5 to about 15 weight percent of the weight of the mixture.
